(19) United States
(12) Patent Application Publication
(10) Pub. No.: US 2026/0105753 A1
(43) Pub. Date: Apr. 16, 2026

(54) IMAGE PROCESSING DEVICE, IMAGE PROCESSING METHOD, AND STORAGE MEDIUM

(71) Applicant: HONDA MOTOR CO., LTD., Tokyo (JP)

(72) Inventors: Taichi Nakamura, Wako-shi (JP); Ryosuke Miyoshi, Wako-shi (JP); Yoshitaka Muramoto, Wako-shi (JP)

(21) Appl. No.: 19/350,077

(22) Filed: Oct. 6, 2025

(30) Foreign Application Priority Data
Oct. 10, 2024 (JP) 2024-177760

(51) Int. Cl. G06V 20/54; G06V 10/764

(52) U.S. Cl. CPC G06V 20/54; G06V 10/764

(57) ABSTRACT

According to an embodiment, an image processing device includes an acquirer configured to acquire images captured by a plurality of cameras, a detector configured to detect objects from the plurality of images acquired by the acquirer, and an integrator configured to perform, when there are objects located in an overlapping area of the images from the plurality of cameras among the objects detected by the detector, an integration process on the objects detected by the plurality of cameras based on a distance between the objects in the overlapping area detected by the plurality of cameras, types of the objects, and history information about a previous integration process on the objects.

### CROSS-REFERENCE TO RELATED APPLICATION

Priority is claimed on Japanese Patent Application No. 2024-177760, filed October 10, 2024, the content of which is incorporated herein by reference.

### BACKGROUND

### Field of the Invention

The present invention relates to an image processing device, an image processing method, and a storage medium.

### Description of Related Art

Conventionally, image processing devices for processing frames captured by first and second cameras whose imaging areas at least partially overlap each other are known (e.g., Japanese Unexamined Patent Application, First Publication No. 2019-168909). Patent Document 1 discloses a process in which, when a first object is detected from a first frame captured by a first camera, a second object is detected from a second frame captured by a second camera, and it is determined that the first and second objects are the same object, the color extraction area is set for the first and second frames and the second frame is corrected and synthesized with the first frame based on the color in each set area.

### SUMMARY

Incidentally, because a process for determining whether or not objects detected from images captured by a plurality of cameras are the same object is based solely on a distance between the objects and types of the objects, it may be difficult to accurately integrate objects extracted from a plurality of camera images as the same object. Therefore, there is a problem because it may be difficult to improve the visibility of an object.

To solve the above-described problem, an objective of the present application is to improve the visibility of objects included in images. Consequently, the present application further improves traffic safety and contributes to the development of a sustainable transportation system.

An image processing device, an image processing method, and a storage medium according to the present invention adopt the following configurations.

(1): According to an aspect of the present invention, there is provided an image processing device including: an acquirer configured to acquire images captured by a plurality of cameras; a detector configured to detect objects from the plurality of images acquired by the acquirer; and an integrator configured to perform, when there are objects located in an overlapping area of the images from the plurality of cameras among the objects detected by the detector, an integration process on the objects detected by the plurality of cameras based on a distance between the objects in the overlapping area detected by the plurality of cameras, types of the objects, and history information about a previous integration process on the objects.

(2): In the above-described aspect (1), the history information is information in which at least common identification information for identifying the objects common to the plurality of cameras and camera-specific identification information separately assigned to the integrated object by each of the plurality of cameras are associated with the objects detected by the plurality of cameras.

(3): In the above-described aspect (1), the integrator iteratively executes the integration process using a plurality of images acquired at predetermined intervals from the plurality of cameras, and the integration process is performed with reference to the history information when a plurality of new objects are detected in the plurality of cameras.

(4): In the above-described aspect (1), the integrator performs the integration process when images whose timings are synchronized are acquired from the plurality of cameras.

(5): In the above-described aspect (2), the integrator generates object information including common identification information of the integrated object, object position information, and object type information, and the object information includes feature information of the object.

(6): In the above-described aspect (5), the integrator generates position information and feature information for the integrated object based on position information for each object and the object feature information before the integrated object is integrated.

(7): In the above-described aspect (1), the integrator decides objects to be integrated with reference to the history information when there is at least one type of a plurality of objects detected from an image captured by a first camera among the plurality of cameras and a plurality of objects detected from an image captured by a second camera different from the first camera.

(8): In the above-described aspect (7), the integrator excludes an object integrated with another object among the plurality of objects from a target of the integration process with reference to the history information for each of the plurality of objects detected from images captured by the first camera or the second camera.

(9): According to another aspect of the present invention, there is provided an image processing method including: acquiring, by a computer, images captured by a plurality of cameras; detecting, by the computer, objects from the plurality of images that have been acquired; and performing, by the computer, when there are objects located in an overlapping area of the images from the plurality of cameras among the detected objects, an integration process on the objects detected by the plurality of cameras based on a distance between the objects in the overlapping area detected by the plurality of cameras, types of the objects, and history information about a previous integration process on the objects.

(10): According to yet another aspect of the present invention, there is provided a computer-readable non-transitory storage medium storing a program for causing a computer to: acquire images captured by a plurality of cameras; detect objects from the plurality of images that have been acquired; and perform, when there are objects located in an overlapping area of the images from the plurality of cameras among the detected objects, an integration process on the objects detected by the plurality of cameras based on a distance between the objects in the overlapping area detected by the plurality of cameras, types of the objects, and history information about a previous integration process on the objects.

According to the above-described aspects (1) to (10), it is possible to improve the visibility of objects included in images.

### BRIEF DESCRIPTION OF THE DRAWINGS

FIG. 1 is a diagram showing an example of the configuration of a mobile object according to an embodiment.

FIG. 2 is an explanatory diagram showing an imaging area of a camera according to the embodiment.

FIG. 3 is a diagram showing an example of a functional configuration of a recognizer.

FIG. 4 is an explanatory diagram of a flow of image processing from object detection to object integration.

FIG. 5 is an explanatory diagram of an example of the content of history information.

FIG. 6 is an explanatory diagram of an example of the content of object information.

FIG. 7 is an explanatory diagram of an example of the generation of history information at time T.

FIG. 8 is an explanatory diagram of the update of history information at time T+α.

FIG. 9 is an explanatory diagram showing the update of history information at time T+β.

FIG. 10 is a flowchart showing an example of a process executed by a control device according to the embodiment.

FIG. 11 is a flowchart showing a modification example of an object integration process in an overlapping area.

FIG. 12 is a flowchart showing an example of a first process.

FIG. 13 is a flowchart showing an example of a second process.

### DESCRIPTION OF EMBODIMENTS

Hereinafter, embodiments of an image processing device, an image processing method, and a storage medium of the present invention will be described with reference to the drawings. Hereinafter, the image processing device mounted on a mobile object will be described. The mobile object is not limited to those traveling on roadways, and may also be capable of traveling in predetermined areas other than roadways. The predetermined area is, for example, a sidewalk. The predetermined area may be a part or all of a roadside strip, bicycle lane, public open space, and the like, or may include all of a sidewalk, roadside strip, bicycle lane, public open space, and the like. The mobile object may be, for example, a four-wheeled or three-wheeled vehicle, or may include a watercraft capable of moving on the ground (on roads) such as a hovercraft, an aircraft capable of traveling on roads, or a stand-up vehicle with a motive power unit.

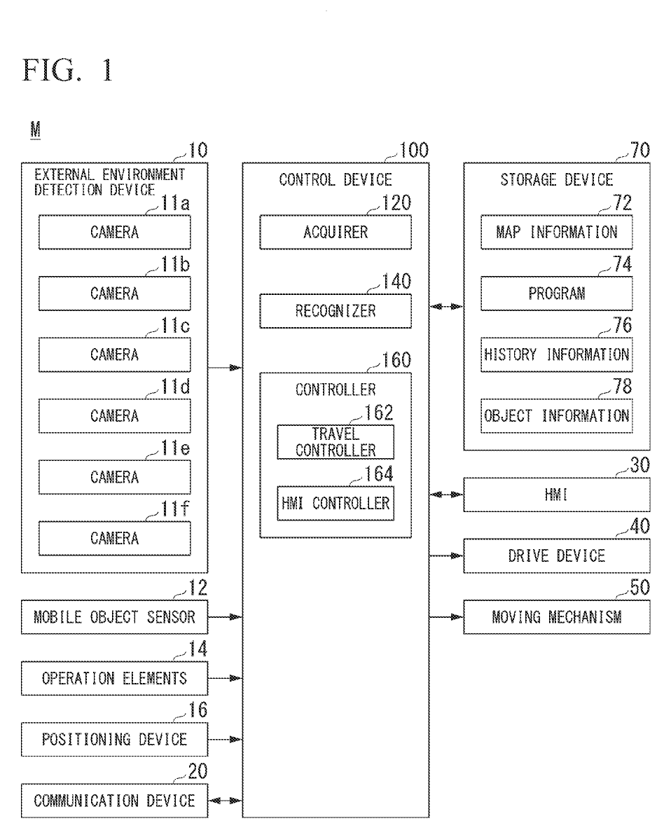

FIG. 1 shows an example of a configuration of a mobile object M according to an embodiment. For example, an external environment detection device 10, a mobile object sensor 12, operation elements 14, a positioning device 16, a communication device 20, a human machine interface (HMI) 30, a drive device 40, a moving mechanism 50, a storage device 70, and a control device 100 are mounted on the mobile object M. Some of these constituent elements that are not essential for the functions of the present invention may be omitted.

The external environment detection device 10 is various types of devices in which a travel direction of the mobile object M is designated as a detection range. The external environment detection device 10 detects an external situation of the mobile object M. The external environment detection device 10 includes, for example, a plurality of cameras 11. Although six cameras 11a to 11f are included in the example of FIG. 1, the number of cameras is not limited thereto. Hereinafter, unless the cameras 11a to 11f are individually identified and described, they will be collectively referred to as a “camera 11.” The camera 11 is an example of an “imager.” In addition to the camera 11, the external environment detection device 10 may include a radar device, a light detection and ranging (LIDAR), and the like.

The camera 11 is, for example, a digital camera using a solid-state image sensor such as a charge-coupled device (CCD) or a complementary metal oxide semiconductor (CMOS). The camera 11 may also be a stereo camera. Each of the plurality of cameras 11a to 11f is attached to any location on the mobile object M and captures images in a corresponding direction within a predetermined imaging area (an angle of view or a viewing angle) from the location to which the camera is attached.

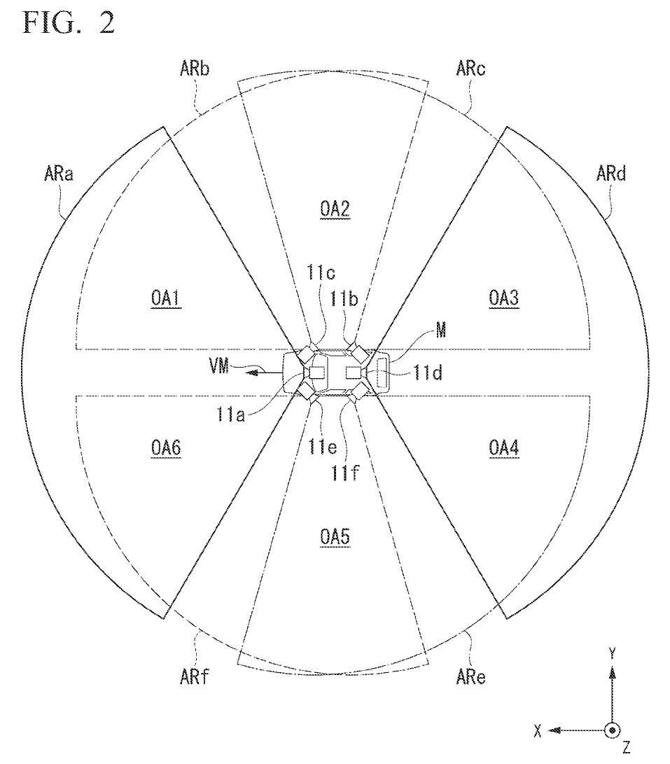

FIG. 2 is an explanatory diagram of imaging areas of the cameras 11a to 11f according to the embodiment. In the example of FIG. 2, it is assumed that the mobile object M is traveling at a speed VM in an X-axis direction in the drawing. In the example of FIG. 2, the camera 11a captures an area ARa including an area in front of the mobile object M. The camera 11b captures an area ARb including an area on the front right of the mobile object M. The camera 11c captures an area ARc including an area in the right rear of the mobile object M. The camera 11d captures an area ARd including an area in the rear of the mobile object M. The camera 11e captures an area ARe including an area in the left rear of the mobile object M. The camera 11f captures an area ARf including an area in the front left of the mobile object M.

As shown in FIG. 2, the image capture areas of the images captured by the plurality of cameras 11a to 11f include overlapping areas OA1 to OA6 that overlap the image capture areas of the other cameras and non-overlapping areas that do not overlap the image capture areas of the other cameras. In the example of FIG. 2, the overlapping area OA1 is an area where the area ARa and the area ARb overlap. The overlapping area OA2 is an area where the area ARb and the area ARc overlap. The overlapping area OA3 is an area where the area ARc and the area ARd overlap. The overlapping area OA4 is an area where the area ARd and the area ARe overlap. The overlapping area OA5 is an area where the area ARe and the area ARf overlap. The overlapping area OA6 is an area where the area ARf and the area ARa overlap. The plurality of cameras 11a to 11f can capture images of the surroundings of the mobile object M (in all directions), and these images can be used to recognize a surrounding situation of the mobile object M (e.g., objects and the like).

Each of the plurality of cameras 11a to 11f, for example, iteratively captures images at predetermined intervals, and the captured images (hereinafter sometimes referred to as “camera images”) are output to the control device 100. In this case, time information (timestamp information) and identification information (camera ID) for identifying the camera may be assigned to each camera image (for each image frame).

Returning to FIG. 1, the radar device of the external environment detection device 10 radiates radio waves such as millimeter waves around the mobile object M and detects at least a position of a physical object (a distance from the physical object and a direction of the physical object) by detecting radio waves (reflected waves) reflected by the physical object. The radar device is attached to any location on the mobile object M. The radar device may detect a position and a speed of the object in a frequency-modulated continuous wave (FM-CW) scheme. The LIDAR radiates light (or electromagnetic waves having a wavelength close to that of light) around the mobile object M and measures scattered light. The LIDAR detects a distance from a target based on a period of time from light emission to light reception. The radiated light is, for example, pulsed laser light. The LIDAR is attached to any location of the mobile object M. Detection results from the radar device and the LIDAR are also output to the control device 100.

The mobile object sensor 12 includes, for example, a speed sensor that detects the speed of the mobile object M, an acceleration sensor that detects acceleration, a yaw rate (angular velocity) sensor that detects a yaw rate (e.g., a rotational angular velocity around a vertical axis passing through the center of gravity of the mobile object M), a direction sensor, an operation amount detection sensor attached to the operation element 14, and the like.

The operation element 14 receives a driving operation from the occupant of the mobile object M. The operation elements 14 include, for example, an operation element for issuing an acceleration/deceleration instruction (e.g., an accelerator pedal, a brake pedal, a speed adjustment dial switch, or a lever), and an operation element for issuing a steering instruction (e.g., a steering wheel). In this case, the mobile object sensor 12 may include an operation amount detection sensor such as an accelerator position sensor, a brake depression amount sensor, or a steering torque sensor. The mobile object M may also include an operation element 14 of an aspect (e.g., a non-circular rotary operation element, a joystick, a button, or the like) other than those described above.

The positioning device 16 is a device that measures a position of the mobile object M. The positioning device 16 is, for example, a Global Navigation Satellite System (GNSS) receiver, and identifies the position of the mobile object M based on signals received from GNSS satellites and outputs position information. The position information of the mobile object M may also be estimated from a position of a Wi-Fi base station to which the communication device 20 mounted on the mobile object M is connected.

The communication device 20, for example, communicates with another vehicle located in the vicinity of the mobile object M using a cellular network, a Wi-Fi network, Bluetooth (registered trademark), dedicated short-range communication (DSRC), or the like or communicates with various types of server devices via a radio base station.

The HMI 30 presents various types of information to the occupant of the mobile object M and receives an input operation from the occupant. The HMI 30 includes, for example, a display and a speaker. The display may be, for example, a liquid crystal display (LCD) or an organic electro luminescence (EL) display device. The display displays various types of images (including videos) in the embodiment. The display may be integrated with an input as a touch panel. The speaker outputs a predetermined sound (e.g., an alarm or the like).

The HMI 30 may also include a microphone, buzzer, touch panel, keys, and the like. The HMI 30 may also include external notification devices such as lamps, displays, and speakers that are provided on the outer panel of the mobile object M and that provide a notification of information to the outside of the mobile object M.

The drive device 40 outputs a driving force (torque) required to move the mobile object M to the moving mechanism 50. For example, the drive device 40 includes a motor that drives drive wheels, a battery that stores electric power to be supplied to the electric motor, and a steering device that adjusts a steering angle of a steering wheel. The drive device 40 may also include an internal combustion engine or a fuel cell as a driving force output means or a power generation means. The drive device 40 may further include a brake device that utilizes a frictional force or air resistance. The drive device 40 receives instructions from the operation element 14 or the travel controller 162 and causes the moving mechanism 50 to perform an operation according to the received instruction.

The moving mechanism 50 is a mechanism for moving the mobile object M along a movement path such as a road. The moving mechanism 50 is, for example, a group of wheels including the steering wheel and the drive wheels. The moving mechanism 50 may, for example, be legs for multi-legged walking, a mechanism that sprays compressed air, or any other movable mechanism.

The storage device 70 is a non-transitory storage device such as a hard disk drive (HDD), a flash memory, or a random-access memory (RAM). The storage device 70 stores, for example, map information 72, a program 74 to be executed by the control device 100, history information 76, object information 78, and the like. While the storage device 70 outside of the control device 100 is shown in FIG. 1, the storage device 70 may be included within the control device 100.

The map information 72 is, for example, information representing road shapes using links indicating roads and nodes connected by the links. The map information 72 may also include point-of-interest (POI) information and the like. The map information 72 may also include, for example, lane boundary information about road markings (hereinafter referred to as markings) for defining lanes and the like. The map information 72 may include road information such as the curvature (or radius of curvature), gradient, and width of the road (or each lane included in the road), traffic regulation information, address information (address and postal code), facility information, telephone number information, and the like. The map information 72 may be updated as needed through communication with other devices, such as the communication device 20 mounted on the mobile object M.

The history information 76 is, for example, information in which history information (history dictionary) related to a previous integration process is associated with each object detected from the camera image captured by the camera 11. For example, for objects detected by the plurality of cameras 11, the history information 76 is associated with at least common identification information (global ID) for identifying the objects common to the plurality of cameras 11, and camera-specific identification information (local ID) separately assigned to the integrated object by each of the plurality of cameras. The object information 78 is, for example, information in which at least position information and type information are associated with each object included in the camera image. The object information 78 may also include object feature information. Details of the history information 76 and the object information 78 will be described below.

### Control device

The control device 100 includes, for example, an acquirer 120, a recognizer 140, and a controller 160. These constituent elements are implemented, for example, by a hardware processor such as a central processing unit (CPU) executing a program (software). Some or all of these constituent elements may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in the storage device 70 or may be stored in a removable storage medium (non-transitory storage medium) such as a DVD or a CD-ROM and installed in the storage device 70 when the storage medium is mounted on a drive device. The acquirer 120 and the recognizer 140 are examples of an “image processing device.” The image processing device may include the HMI 30 and the HMI controller 164 to be described below.

The acquirer 120 acquires information from constituent elements (e.g., the external environment detection device 10, the mobile object sensor 12, the positioning device 16, the communication device 20, the HMI 30, the storage device 70, and the like) other than the control device 100 installed on the mobile object M. For example, the acquirer 120 acquires camera images captured by the plurality of cameras 11a to 11f.

The recognizer 140 recognizes a surrounding situation of the mobile object M (within a predetermined distance from the mobile object M) based on the information acquired by the acquirer 120. The function of the recognizer 140 will be described in detail below.

The controller 160 controls all constituent elements included in the mobile object M. For example, the controller 160 includes a travel controller 162 and an HMI controller 164. The HMI controller 164 is an example of an “alert controller.”

The travel controller 162 executes driving control for controlling at least one of the steering and speed of the mobile object M, based on, for example, a recognition result from the recognizer 140 and the like. For example, the travel controller 162 performs steering control so that the mobile object M is centered on the travel path recognized by the recognizer 140 (or so that the mobile object M is prevented from deviating from the movement path defined by a marking (boundary line)). The travel controller 162 may also execute the above-described driving control so that contact between the mobile object M and an obstacle recognized by the recognizer 140 is avoided. The travel controller 162 may also execute driving control such as an adaptive cruise control system (ACC) or auto lane change (ALC) by controlling at least one of the steering and speed of the mobile object M in response to an instruction from the occupant input from the HMI 30.

The HMI controller 164 notifies (informs) the occupant of the mobile object M of predetermined information via the HMI 30, and receives information input via the HMI 30. The predetermined information includes, for example, information about the traveling of the mobile object M, such as information about the state of the mobile object M (e.g., a speed, a current position, the remaining fuel, or the like) and information about the driving control. The predetermined information may also include information about the surrounding situations recognized by the external environment detection device 10 (e.g., information about objects located in the vicinity of the mobile object M). The predetermined information may also include information unrelated to the traveling of the mobile object M, such as television programs, content stored in storage media such as DVDs (e.g., movies), and the like. The HMI controller 164 may also output inquiry information for the occupant, recognition results of the recognizer 140, or the like to the HMI 30. The HMI controller 164 may cause the HMI 30 to output an alarm if there is a possibility of contact between the mobile object M and an obstacle, for example, based on the relative position or relative speed between the mobile object M and the obstacle.

### Recognizer

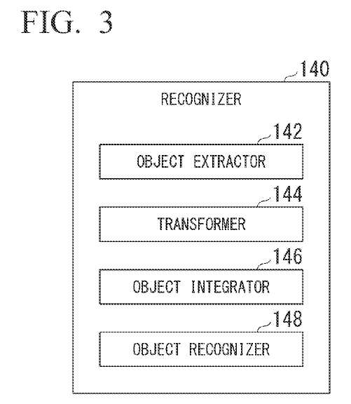

Next, the function of the recognizer 140 will be described in detail. FIG. 3 is a diagram showing an example of the functional configuration of the recognizer 140. The recognizer 140 includes, for example, an object detector 142, a transformer 144, an object integrator 146, and an object recognizer 148. The object detector 142 is an example of a “detector.” The object integrator 146 is an example of an “integrator.”

The object detector 142 recognizes objects located near the mobile object M (within a predetermined distance from the mobile object M) based on information input from the detection result of the external environment detection device 10 (e.g., which are camera images captured by the plurality of cameras 11a to 11f, and may also include detection results from the radar or LIDAR). Objects include, for example, traffic participants such as other vehicles, pedestrians, and bicycles and the like. The objects may also include traffic signals, curbs, medians, utility poles, road signs, and the like.

For example, the object detector 142 performs a known analysis process (e.g., edge extraction, feature extraction, pattern matching, or the like) on the camera images captured by each of the plurality of cameras 11a to 11f, and detects the type (category) of the object from the analysis results. The object detector 142 may also detect feature information such as the object’s shape (outline), size, and color from the analysis results. The object detector 142 detects the location of each detected object. The object position is, for example, the position (pixel position) of the object’s reference point (e.g., a center or an edge) in the camera image. The object detector 142 may also detect the object’s speed (which may be a speed relative to the mobile object M).

The object detector 142 may detect information about objects from the camera images captured by each of the plurality of cameras 11a to 11f using a trained model that has been trained to input camera images and output information such as the object’s presence, position, and type. The trained model may, for example, be a model that uses deep learning that is a machine learning function based on artificial intelligence (AI) and the like. The trained model may be stored in the storage device 70 or acquired from an external device via the communication device 20. The object detector 142 may detect objects located in the vicinity of the mobile object M by performing a sensor fusion process that includes detection results of the radar device, the LIDAR, and the like included in the external environment detection device 10.

The transformer 144 uses a mapping process such as homography transformation (projection transformation) on the images captured by each camera to transform the coordinate system of the camera images into another coordinate system for performing an object integration process or the like. The other coordinate system is, for example, a bird’s-eye view image system in which the mobile object M is viewed from above, in which the mobile object M serves as the reference point (origin). Hereinafter, this coordinate system will be referred to as a “mobile object coordinate system.” The transformation may be performed using, for example, a known projective transformation matrix, or may use other methods. The transformer 144 also transforms the position information for each object included in the object information in correspondence with the transformed mobile object coordinate system.

The object integrator 146 classifies the objects detected by the object detector 142 into objects included in the above-described non-overlapping area and objects included in the overlapping areas OA1 to OA6. When an object is located in the overlapping areas OA1 to OA6, the object integrator 146 performs an integration process on the objects detected by each of the plurality of cameras 11a to 11f based on a distance between the objects detected by each of the plurality of cameras 11a to 11f, an object type, and history information about a previous object integration process.

The object recognizer 148 registers and manages the position information, type information, and the like of each object in the object information 78 based on detection results of the object detector 142 and integration processing results of the object integrator 146. The object recognizer 148 recognizes objects near the mobile object M obtained from camera images based on the object information 78 and the like.

The recognizer 140 may also recognize road markings and stop lines on roads located near the mobile object M, as well as other markings (e.g., speed limits) drawn on the road (travel path) as objects. The recognizer 140, for example, may also recognize the behavior of the mobile object M based on a detection result of the mobile object sensor 12. For example, the recognizer 140 recognizes a lateral position of the mobile object M relative to the path (a position of a movement path in a width direction) and a posture (orientation) of the mobile object M relative to an extension direction of the movement path based on a positional relationship of the mobile object M relative to the movement path. For example, the recognizer 140 may recognize a deviation of a reference point of the mobile object M from the center of the lane and an angle formed between a line connected to the center of the lanes and the travel direction of the mobile object M as the relative position and posture of the mobile object M relative to the movement path.

The recognizer 140 may also recognize the state of the driver driving the mobile object M. The state of the occupant, for example, is a state of whether or not the driver’s state is suitable for driving the mobile object M. Whether or not the driver is suitable for driving the mobile object M, for example, may be determined based on the behavior of the mobile object M while the mobile object M is driven by the driver, may be determined based on the driver’s inattentiveness, or may be determined according to a combination thereof.

For example, the recognizer 140 may determine that the behavior of the mobile object M is unstable when a change in a yaw rate or a change in a speed (or acceleration) during a predetermined period of time is greater than or equal to a threshold value based on the detection results from the mobile object sensor 12 and recognize that the driver’s state is unsuitable for driving the mobile object M. The recognizer 140 may also detect the driver’s line of sight from images captured by an internal camera (not shown) capable of capturing the driver’s line of sight, and determine that the driver is in an inattentive state and is in an unsuitable state for driving the mobile object M if the detected line of sight is at a predetermined angle or greater in the travel direction of the mobile object M during a predetermined period of time or longer.

### Image processing

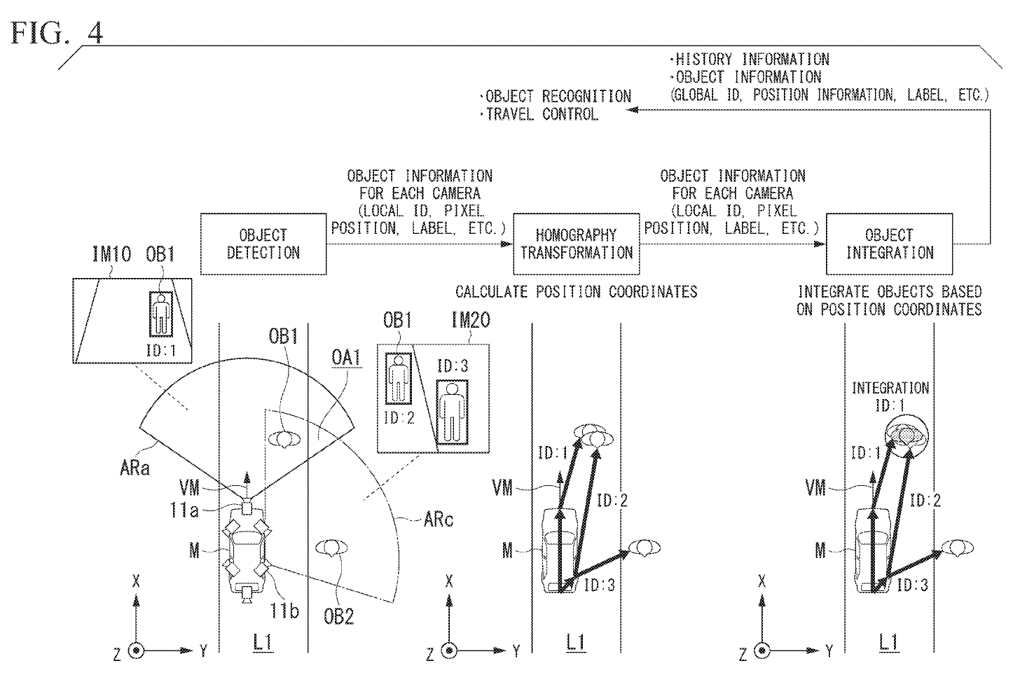

Next, a flow of image processing from object detection to object integration in the embodiment will be described. FIG. 4 is an explanatory diagram of the flow of image processing from object detection to object integration. The processing shown in FIG. 4 is iteratively executed, for example, for each of camera images (image frames) captured at predetermined intervals by the plurality of cameras 11. The object integrator 146 may execute the integration process, for example, when time-synchronized camera images (e.g., shutter-synchronized camera images) are acquired from a plurality of cameras corresponding to the overlapping area. Whether or not the images are synchronized can be determined, for example, according to whether or not the time information assigned to each camera image matches. It is possible to more accurately integrate objects using synchronized camera images.

In FIG. 4, it is assumed that the mobile object M is traveling on a lane L1 at a speed VM in the extension direction (X-axis direction in the drawing). As an example, in FIG. 4, it is assumed that an object OB1 is located in the overlapping area OA1 between the area ARa captured by the camera 11a and the area ARb captured by the camera 11b, and an object OB2 is further located in a non-overlapping area of the area ARb.

First, the object detector 142 detects objects in one camera image captured by each of the cameras 11a to 11f. When an object is present, individual identification information (hereinafter referred to as a local ID) for identifying the object is set for each of the cameras 11a to 11f. In the example of FIG. 4, the object OB1 is located in the overlapping area OA1, the object detector 142 sets local ID “1” to identify the object OB1 for a camera image IM10 captured by the camera 11a and sets local ID “2” to identify the object OB1 for a camera image IM20 captured by the camera 11b. Because the object OB2 is also located in the camera image IM20, the object detector 142 sets local ID “3” for the object OB2.

At this time, the object recognizer 148 generates object information for each object detected by each camera 11, including a local ID, position information (a pixel position of the object in the camera image), and a label (e.g., an object type). The object information may include feature information (such as a color, shape, and size) of the object detected by the object detector 142. The object information at this stage is different from the final object information 78, but may be stored in the storage device 70 at this stage.

When the same object is detected in subsequent object detections (object detection using image frames after a predetermined time), the object detector 142 sets the same local ID. Whether or not the objects are the same is determined based on the position information and feature information acquired in the previous object detection. For example, the object detector 142 determines that the same object has been detected when an amount of change in the position from the previous detection is less than a first threshold value and a degree of similarity of the feature information is greater than or equal to a second threshold value.

Subsequently, the transformer 144 performs projective transformation, such as homography transformation, on each camera image to acquire position coordinates of each object in the image after the transformation. For example, the transformer 144 performs projective transformation on each camera image based on an installation position and an imaging area of each camera and the like to generate an image in the mobile object coordinate system. The transformer 144 combines a plurality of images after the transformation into a single image based on coordinate information. The transformer 144 also transforms the position information (pixel positions) of objects included in the image after the transformation into position information (position coordinates) in the mobile coordinate system, and updates the position information for each local ID included in the object information based on the transformation result.

Subsequently, the object integrator 146 classifies objects detected by the object detector 142 into objects located in non-overlapping areas and objects located in overlapping areas. In the example of FIG. 4, the objects are classified into an object with local ID “3” located in a non-overlapping area and objects with local IDs “1” and “2” located in an overlapping area. Also, the object integrator 146 determines whether or not the two objects with local IDs “1” and “2” located in the overlapping area are the same object, and integrates the objects based on a determination result.

For example, the object integrator 146 determines that the objects are the same when the distance between the position information of the object with local ID “1” and the position information of the object with local ID “2” is less than a threshold value and the labels (types) included in the object information are the same. The object integrator 146 determines that the objects are not the same (or are different objects) when the distance is greater than the threshold value or when the labels are different. In addition to the above-described determination conditions, the object integrator 146 may also compare the feature information of the objects and determine that the compared objects are the same if the degree of similarity is greater than or equal to the threshold value. When camera images captured by the cameras 11a to 11f are used, because there are six overlapping areas OA1 to OA6 as described above, the object integrator 146 performs similar determinations for the overlapping areas OA1 to OA6.

For objects determined to be the same, the object integrator 146 integrates the object information and generates (updates) the history information 76.

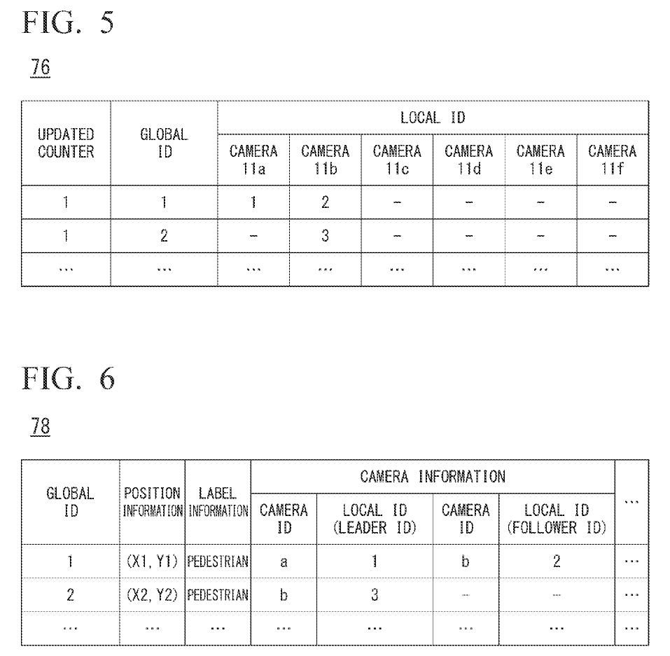

FIG. 5 is an explanatory diagram of an example of the content of the history information 76. In the history information 76, an updated counter, a global ID, and a local ID for each of the cameras 11a to 11f are associated. The updated counter is a counter related to previous object detection results and integration results and is used to determine whether information (records) corresponding to a global ID should be retained in the history information 76, updated, or deleted. The global ID is identification information for identifying objects commonly assigned in all cameras as a result of the integration process. Global IDs are not only assigned when objects detected from camera images of the plurality of cameras are integrated, but are also assigned to objects that are not integrated (including not only objects located in overlapping areas but also objects located in non-overlapping areas). The local ID is identification information used to identify objects detected from the camera images of the cameras 11a to 11f for each camera.

In the history information 76 shown in FIG. 5, the object with local ID “1” included in the camera image IM10 captured by the camera 11a and the object with local ID “2” included in camera image IM20 captured by the camera 11b are determined to be the same object, and therefore unique global ID “1” is set for the object and stored in the history information 76. In the history information 76, global ID “2” is set for the object with local ID “3” included in the camera image IM20 captured by the camera 11b and stored in the history information 76.

When a new record related to the above-described information is stored in the history information 76 as a result of image processing such as an object detection or integration process, the object integrator 146 sets a value of the updated counter to “1.” When the objects with a stored combination of a global ID and a local ID are detected or integrated during image processing using the next camera image to be processed, the object integrator 146 does not update the updated counter. On the other hand, when an object corresponding to a target local ID is not present (or is not detected) in the camera image (or is absent), the object integrator 146 increments the value of the updated counter associated with the local ID by 1. The object integrator 146 determines whether the value of the updated counter is greater than or equal to a threshold value while iteratively performing the above-described process. When the value is greater than or equal to the threshold value, the record information for the target global ID is deleted. In other words, when an object previously detected from the camera image has not been detected a predetermined number of times or more, the object information is deleted from the history information 76. Thereby, it is possible to suppress an increase in an amount of data because it is possible to delete information about objects that are no longer necessary. By reducing the amount of data, it is also possible to reduce the processing load when the comparison process is performed with the history information 76.

The object recognizer 148 generates or updates object information 78 for each global ID included in the history information 76 generated or updated by the object integrator 146. FIG. 6 is an explanatory diagram of an example of the content of the object information 78. In the example of FIG. 6, the object information 78 is, for example, information in which a global ID is associated with position information, label information, and camera information. The object information 78 may also include feature information.

The position information is position information in a post-transformation image of an object in which a global ID is set. When objects in an overlapping area are integrated by an integration process, the position information may be an average of the position information acquired from one camera image and the position information acquired from the other camera image, or may be predetermined position information of one of the camera images. When the feature information is included in the object information 78, the integrated feature information is generated using a similar method. In the case of the feature information, all of the feature information detected in both camera images may be stored. The label information includes, for example, the object type (e.g., a pedestrian, an automobile, a bicycle, or the like), but is not limited thereto, and may include a part of the feature information (e.g., color information).

Camera information includes a camera ID, which is the identification information of each camera that has recognized an object to which a global ID is assigned, and a local ID for the object for each camera. Here, the local IDs of the two cameras when objects are integrated may be managed separately as a leader ID and a follower ID. The leader ID is a local ID of an object detected by one reference camera (the first camera) between the two cameras for capturing the overlapping area. The follower ID is a local ID of an object detected by the other camera (the second camera). For example, in the areas ARa to ARb captured by the six cameras 11a to 11f, it is assumed that the camera corresponding to the first captured area is designated as the first camera and the camera corresponding to the subsequently captured area is designated as the second camera, based on a right-handed rotation (clockwise rotation) around the mobile object M. For example, in the case of the overlapping area OA1 in the example of FIG. 2, the camera 11a corresponding to the area ARa is the first camera, and the camera 11b corresponding to the area ARb is the second camera.

The object recognizer 148 recognizes objects in the vicinity of the mobile object M based on the object information 78. The controller 160 creates a behavior plan for the mobile object M and the like based on the positional relationship between the recognized objects and the mobile object M, and executes travel control for causing the mobile object M to travel in accordance with the behavior plan. The HMI controller 164 generates images and sounds indicating the recognition results (e.g., information about objects near the mobile object M) from the recognizer 140 and outputs the images and sounds from the HMI 30. It is possible to improve the visibility of objects included in the image by providing information about objects that have undergone the above-described image processing and the like. The HMI controller 164 may also cause the HMI 30 to output an alarm or the like when there is a possibility that the mobile object M will come into contact with an object, based on the relative distance and relative speed between the mobile object M and the object and the like.

In subsequent image processing that is performed at predetermined intervals, a new record is not added to the history information 76 when the same local ID at the time of detection exists and a new record is added to the history information 76 when the same local ID does not exist, with reference to the above-described history information 76.

When a plurality of objects are located in the overlapping area, the object integrator 146 extracts candidates for integration, refers to the history information 76 based on the local ID of the extracted candidate, and manages the objects based on the content located in the history information 76.

### Generation and update of history information

Here, a specific example in which information stored in the history information 76 in the object integrator 146 is generated and updated will be described using the drawings.

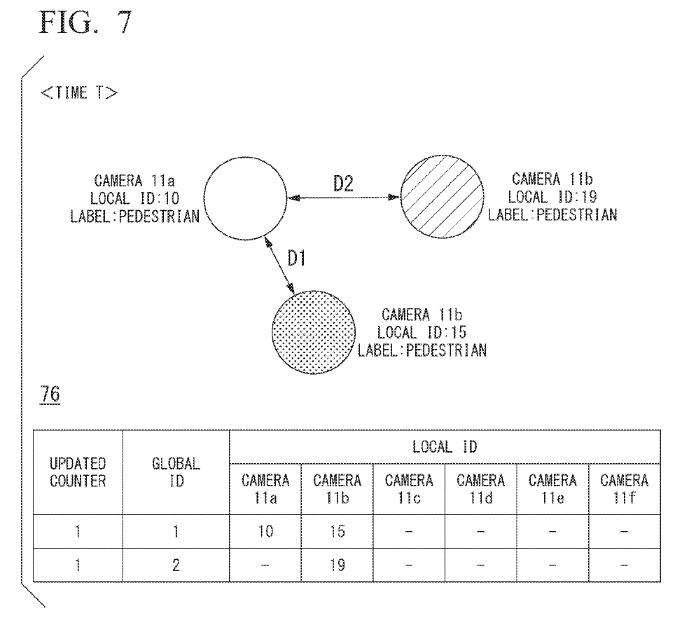

FIG. 7 is an explanatory diagram of an example in which the history information 76 is generated at time T. The example in FIG. 7 shows an example in which an object is recognized in an overlapping area OA1 between an area ARa captured by the camera 11a (an example of a first camera) and an area ARb captured by the camera 11b (an example of a second camera). In the example in FIG. 7, it is assumed that an object with a local ID set to “10” is detected from the camera image captured by the camera 11a and an object with a local ID set to “15” and an object with a local ID set to “19” are detected from the camera image captured by the camera 11b. It is assumed that the label information for each of these objects is assumed to be the same type (e.g., a pedestrian).

In this case, the object integrator 146 compares a distance D1 between the object with local ID “10” and the object with local ID “15” with a distance D2 between the object with local ID “10” and the object with local ID “19” and integrates the objects with a shorter distance that is less than the threshold value. In the example of FIG. 7, because the distance D1 is less than the distance D2 and is also less than the threshold value, the object with local ID “10” and the object with local ID “15” are considered to be the same object and information about the paired local IDs is registered in the history information 76. The object with local ID “19” is not integrated with another object and is registered in the history information 76.

Specifically, as shown in FIG. 7, the object integrator 146 sets global ID “1” for the object resulting from the integration of the object with local ID “10” and the object with local ID “15,” registers the objects together with the paired local IDs in the history information 76, and sets the value of the updated counter to the initial value of “1.” For the object with global ID “1,” local ID “10” of the camera 11a is the leader ID and local ID “15” of the camera 11b is the follower ID. Global ID “2” is set for the object with local ID “19” and is registered in the history information 76 and the value of the updated counter is set to the initial value of “1.” The object recognizer 148 generates the object information 78 for each global ID, in correspondence with the information of the history information 76.

In the next or subsequent integration process, when there is at least one type of a plurality of objects detected from camera images captured by one camera (a first camera) and a plurality of objects detected from camera images captured by another camera (a second camera different from the first camera) among the plurality of cameras for capturing images of the overlapping area, the object integrator 146 decides objects to be integrated with reference to the history information 76. For example, in the next integration process, as in FIG. 7, when an object with a local ID set to “10” is detected from camera images captured by the camera 11a, and an object with a local ID set to “15” and an object with a local ID set to “19” are detected from camera images captured by the camera 11b, a comparison process is performed with the history information 76 using the local IDs, and the objects with local IDs “10” and “15” are recognized as the integrated objects. Thereby, it is possible to recognize integrated objects at higher speed.

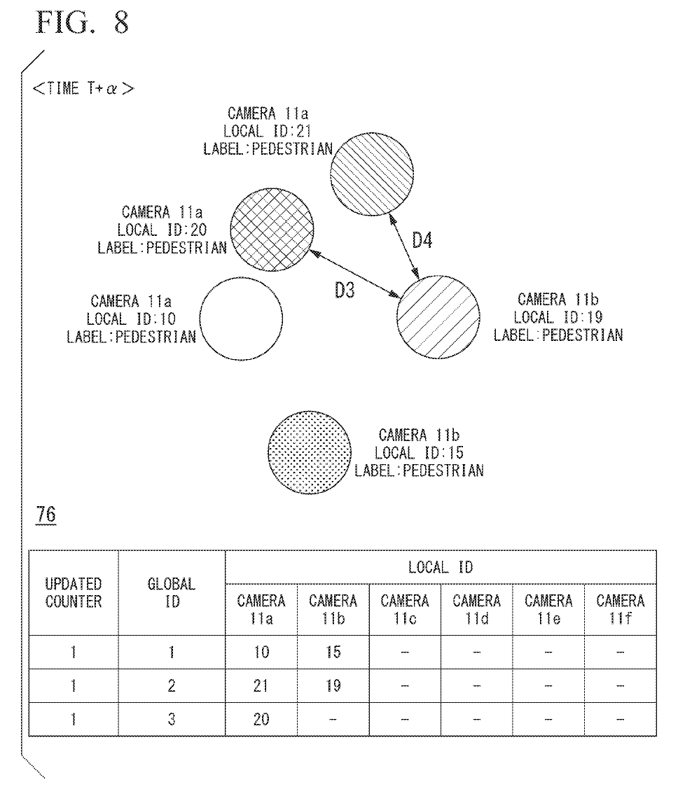

FIG. 8 is an explanatory diagram of the update of the history information 76 at time T+α. In the example of FIG. 8, the object detection results in the overlapping area OA1 at time T+α when time α (α > 0) has elapsed from time T shown in FIG. 7 are shown. At time T+α, compared to the scene at time T shown in FIG. 7, there is a difference because two objects with local IDs “20” and “21” have been detected in addition to the object with local ID “10” from the camera image of the camera 11a. The label information for these objects is assumed to indicate the same pedestrian.

In this case, because a plurality of new objects have been detected from the plurality of cameras 11a and 11b, the object integrator 146 performs an integration process with reference to the history information 76. For example, the object integrator 146 compares detected local IDs “10,” “20,” and “21” of the camera 11a and local IDs “15” and “19” of the camera 11b with the history information 76. Here, local ID “10” of the camera 11a and local ID “15” of the camera 11b have already been registered as a pair. Therefore, the object integrator 146 excludes the objects with local IDs “10” and “15” that have already been integrated from a target of the current integration process. Also, the object integrator 146 determines whether or not to integrate the remaining object with local ID “19” with the object with local ID “20” or “21.” Specifically, the object integrator 146 compares a distance D3 between the object with local ID “20” and the object with local ID “19” with a distance D4 between the object with local ID “21” and the object with local ID “19” and integrates objects with a shorter distance that is less than a threshold value. In the example of FIG. 8, because the distance D4 is less than the distance D3 and is less than the threshold value, information about the paired local IDs of the object with local ID “21” and the object with local ID “19” as the same object is registered in the history information 76. In this case, because a global ID has already been assigned to local ID “19,” the content of the local ID is updated in a state in which the same global ID is kept. As shown in FIG. 8, the object integrator 146 does not integrate the object with local ID “20” with another object, but assigns new global ID “3” and registers new global ID “3” in the history information 76.

In this way, it is possible to omit a process for objects that have already been integrated (paired) by performing the integration process with reference to the history information 76. Therefore, it is possible to reduce the overall processing load of the integration process and enable more rapid object recognition.

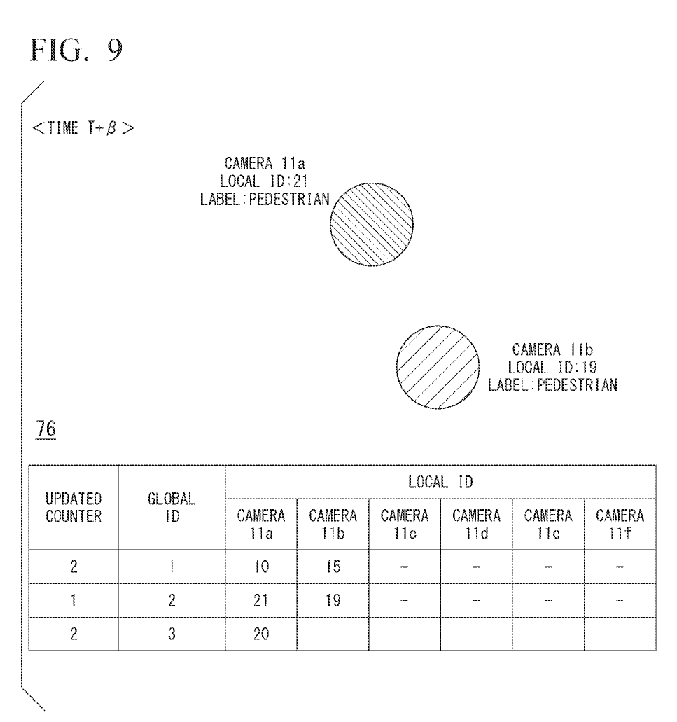

FIG. 9 is an explanatory diagram of the update of the history information 76 at time T+β. In the example in FIG. 9, the object detection results in the overlapping area OA1 at time T+β (β>α) when a predetermined time has elapsed from time T+α shown in FIG. 8 are shown. At time T+β, three objects with local IDs “10,” “15,” and “20” have not been detected (or are absent), compared to the situation at time T+α. In this case, the object integrator 146 increments a value of the updated counter included in the records with global IDs “1” and “3” corresponding to the absent objects by 1 and sets the incremented value to “2.” In this way, a value of the counter for objects that are no longer detected from the next image processing is incremented and a target record is deleted when the counter value reaches or exceeds a threshold value, such that old information can be deleted and an increase in the amount of data can be suppressed.

### Processing flow

Next, a process executed by the control device 100 according to the embodiment will be described. Hereinafter, among processes performed by the control device 100, a process for recognizing objects by performing an integration process on the objects mainly detected from camera images captured by the plurality of cameras and the like will be mainly described. The process to be described below is executed iteratively, for example, at predetermined intervals.

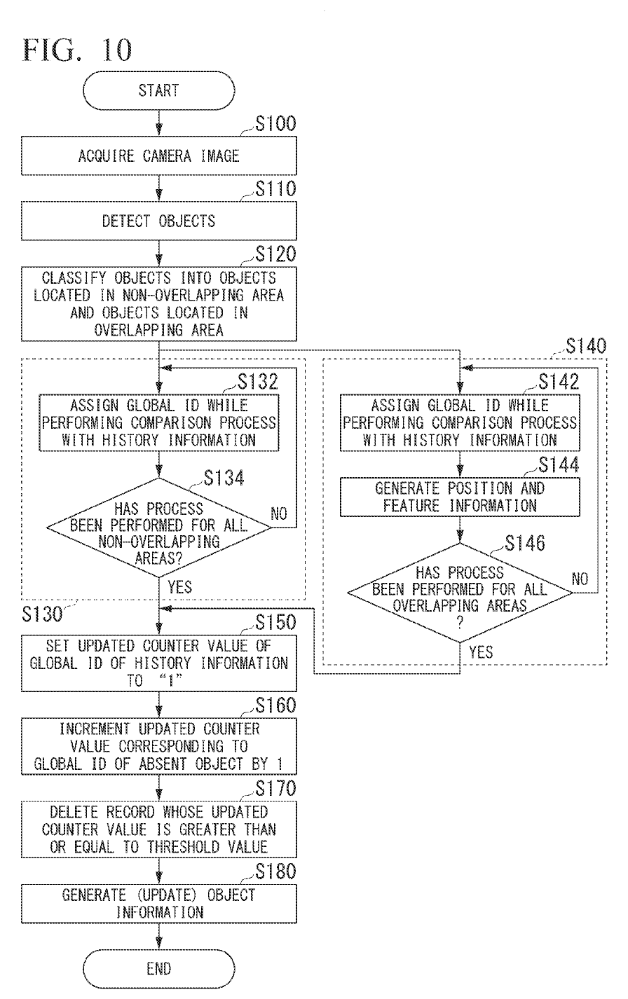

FIG. 10 is a flowchart showing an example of a process executed by the control device 100 according to the embodiment. In the example of FIG. 10, the acquirer 120 acquires a plurality of camera images captured by the plurality of cameras 11a to 11f installed on the mobile object M (step S100). Subsequently, the object detector 142 detects objects included in each acquired camera image (step S110). Subsequently, the object integrator 146 classifies the detected objects into objects in a non-overlapping area and objects in an overlapping area (step S120). In the processing of step S120, a process for performing transformation into an image in a mobile object coordinate system using projective transformation or the like in advance may be performed.

Subsequently, the object integrator 146 performs non-overlapping area processing in step S130 when an object is located in a non-overlapping area and performs overlapping area processing in step S140 when an object is located in an overlapping area. Either step S130 or step S140 may be performed first, or steps S130 and S140 may be performed in parallel using a multiprocessor or the like.

In the processing of step S130 (non-overlapping area processing), the object integrator 146 assigns a global ID for the object while performing a comparison process with the history information 76 based on the local ID for each camera for the object located in the non-overlapping area (step S132). In the processing of step S132, the object integrator 146 does not generate a record with a new global ID because the object has already been given a global ID when the same local ID of the same camera already exists for the local ID for each camera contained in the history information 76. On the other hand, when the same local ID does not exist for the same camera, the object integrator 146 assigns a new global ID to the object, associates the new global ID with the local ID, and registers an association result in the history information 76.

Subsequently, the object integrator 146 determines whether or not the process has been performed for all non-overlapping areas (step S134). When the process has not been performed, the process returns to step S132. In other words, the processing of step S132 is iterated until the process is completed for all non-overlapping areas of the plurality of cameras 11a to 11f.

In the processing of step S140 (overlapping area process), the object integrator 146 assigns a global ID for each object while performing the comparison process with the history information 76 based on the local ID for each camera for the object located in the overlapping area (step S142). In the processing of step S142, when there are a plurality of pairs of cameras and local IDs among the local IDs for the cameras included in the history information 76 (there are paired local IDs), the object integrator 146 does not assign a new global ID because a global ID has already been assigned to the object. On the other hand, if there is no pair of the same camera and local ID, the object integrator 146 assigns a global ID to its object. As described above, the object integrator 146 determines whether or not the objects are the same based on the distance between the objects in the overlapping area of each image and their labels (types), assigns a global ID to each object as a single object when it determined that the objects are the same, assigns a global ID to each object when it determined that the objects are not the same, and registers the global IDs in the history information 76 in association with the local IDs.

After the processing of step S142, the object integrator 146 generates position and feature information for the objects to which global IDs have been assigned (step S144). For example, when objects in each image are integrated, the object integrator 146 integrates the position and feature information of each object by an averaging process or the like to generate position and feature information after the integration. Subsequently, the object integrator 146 determines whether or not a process has been performed on all overlapping areas (step S146). When the process has not been performed, the process returns to step S142. In other words, the process is iterated until the processing of steps S142 and S144 is completed for all overlapping areas.

Subsequently, the object integrator 146 sets an updated counter value for the global ID of the history information to “1” (initial value) when the history information 76 is generated (or updated) (step S150) and increments the updated counter value for the absent object included in the history information by 1 when an object corresponding to the global ID within the record information included in the history information is not detected (or is absent) in the camera image (step S160). Subsequently, the object integrator 146 deletes records included in the history information 76 whose updated counter value is greater than or equal to a threshold value (step S170). Subsequently, the object recognizer 148 generates (or updates) object information 78 about the object for which the global ID has been set (step S180). Thereby, the process of this flowchart ends.

### Modification examples

In the embodiment, instead of (or in addition to) performing the above-described integration process using the history information 76, an integration process may be further performed by classifying conditions into more detailed conditions. For example, when a plurality of objects that are candidates for integration with a single object in an overlapping area are detected, the object integrator 146 performs the integration process with reference to the position information of each object and the history information 76. In this case, the object integrator 146 performs an object integration process using the local ID (leader ID) of the object detected by one (first camera) of the plurality of cameras capturing images of the overlapping area, which serves as a reference, and the local ID (follower ID) of the object detected by the other camera (second camera).

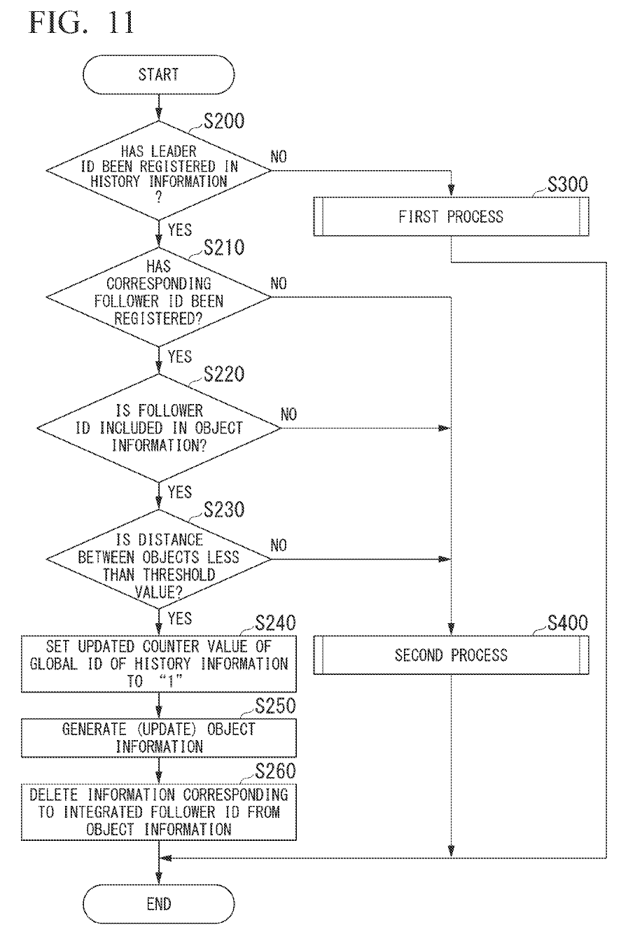

FIG. 11 is a flowchart showing a modification example of the object integration process in the overlapping area. In the example of FIG. 11, the object integrator 146 determines whether or not the leader ID for the object has been registered in the history information 76 (step S200). When it is determined that the leader ID has been registered, the object integrator 146 determines whether or not the follower ID corresponding to the leader ID has been registered (step S210). When it is determined that the follower ID has been registered, the object integrator 146 determines whether or not the follower ID is included in the object information 78 (step S220). When it is determined that the follower ID is included in the object information 78, the object integrator 146 determines whether or not a distance between the two objects corresponding to the leader ID and the follower ID is less than a threshold value (step S230). When it is determined that the distance is less than the threshold value, the object integrator 146 sets the updated counter value for that global ID in the history information to its initial value of “1” (step S240) and generates (updates) object information (step S250). Subsequently, the object recognizer 148 deletes the record information corresponding to the integrated follower ID from the object information (step S260).

When it is determined that the leader ID has not been registered in the history information 76 in the processing of step S200, the object integrator 146 executes a first process to be described below (step S300). When it is determined that the corresponding follower ID has not been registered in the processing of step S210, when it is determined that the follower ID is not included in the object information 78 in the processing of step S220, or when it is determined that the distance between objects is not less than the threshold value in step S230, the object integrator 146 executes a second process to be described below (step S400). Thereby, the process of this flowchart ends.

### First process: step S300

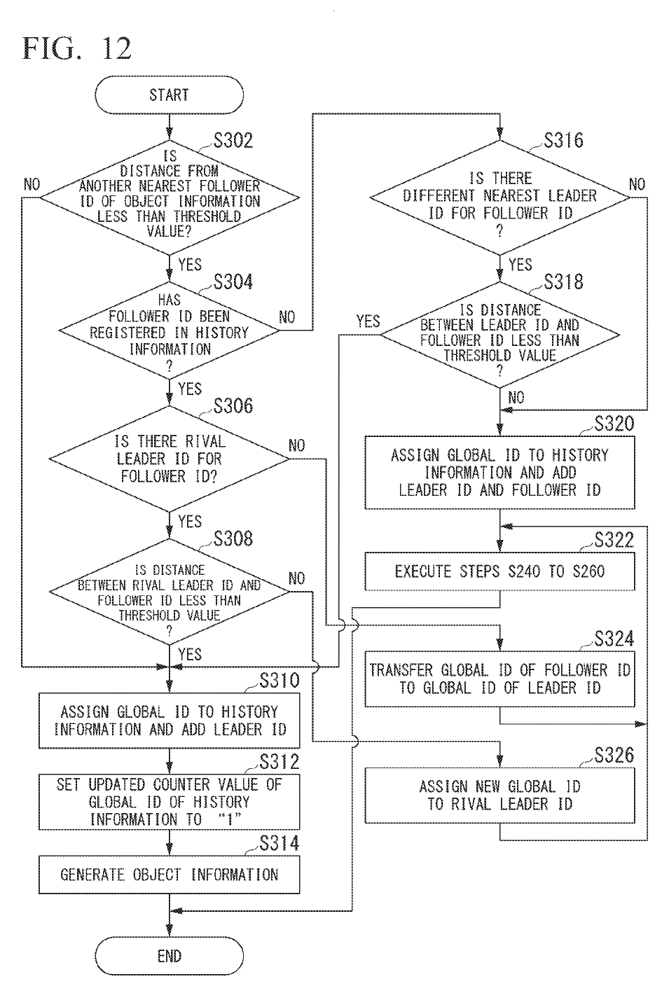

FIG. 12 is a flowchart showing an example of the first process. In the example of FIG. 12, the object integrator 146 determines whether or not a distance from another nearest follower ID of the object information 78 is less than a threshold value (step S302). When it is determined that the distance is less than the threshold value, the object integrator 146 determines whether or not the follower ID has been registered in the history information 76 (step S304). When it is determined that the follower ID has been registered, the object integrator 146 determines whether or not there is a rival leader ID for the follower ID (step S306). Rivals are a plurality of candidate objects to be integrated and a rival leader ID is a leader ID (the local ID of the first camera) for the plurality of candidate objects.

When it is determined that there is a rival leader ID, the object integrator 146 determines whether or not the distance between the rival leader ID and the follower ID is less than a threshold value (step S308). When it is determined that the distance is less than the threshold value or when it is determined that the distance from the nearest follower ID is not less than the threshold value in the processing of step S302, the object integrator 146 assigns a global ID to the history information 76 and adds the leader ID (step S310). Subsequently, the object integrator 146 sets the updated counter value for the global ID of the history information 76 to “1” (step S312). Subsequently, the object recognizer 148 generates object information 78 corresponding to the global ID (step S314).

When it is determined that the follower ID is not registered in the history information 76 in the processing of step S304, the object integrator 146 determines whether or not there is a different nearest leader ID for the follower ID (step S316). When it is determined that there is a nearest leader ID, the object integrator 146 determines whether or not the distance between the leader ID and the follower ID is less than a threshold value (step S318). When it is determined that the distance is less than the threshold value, the object integrator 146 executes the above-described processing of steps S310 to S314. When it is determined that the distance is not less than the threshold value or when it is determined that there is no different nearest leader ID for the follower ID in the processing of step S316, the object integrator 146 assigns a global ID to the history information 76 and adds the leader ID and the follower ID (step S320). Subsequently, the object integrator 146 executes the processing of steps S240 to S260 described above (step S322).

When it is determined that there is no follower ID for a rival leader ID in the processing of step S306, the object integrator 146 transfers the global ID for the follower ID to the global ID for the leader ID (step S324) and then performs the processing of step S322. When it is determined that the distance between the rival leader ID and the follower ID is not less than the threshold value in the processing of step S308, the object integrator 146 assigns a new global ID to the rival leader ID (step S326) and then executes the processing of step S322. Thereby, the process of this flowchart ends.

### Second process: step S400

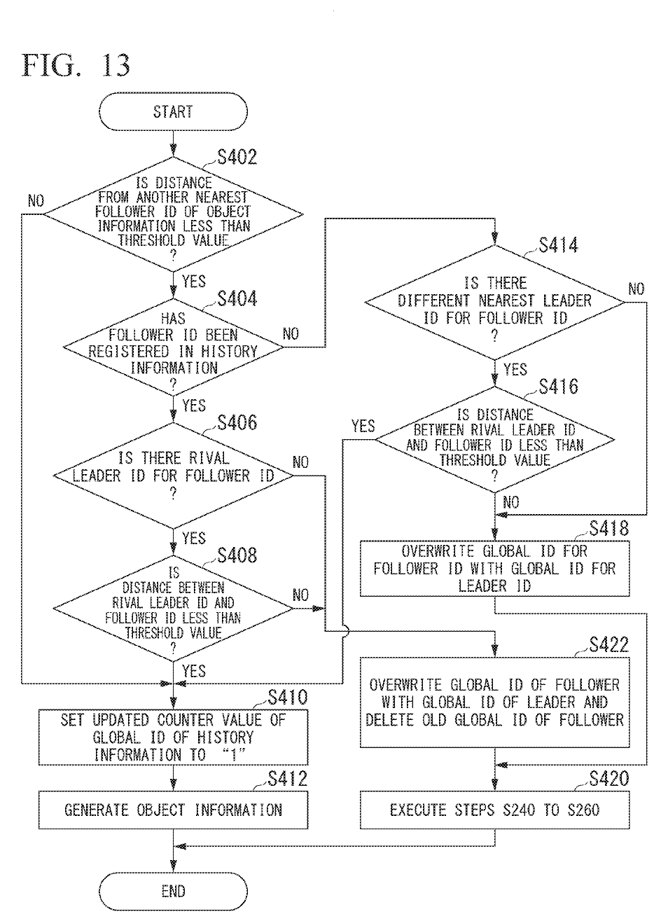

FIG. 13 is a flowchart showing an example of the second process. In the example of FIG. 13, the object integrator 146 determines whether or not the distance from another nearest follower ID in the object information is less than the threshold value (step S402). When it is determined that the distance from the nearest follower ID is less than the threshold value, the object integrator 146 determines whether or not the follower ID has been registered in the history information 76 (step S404). When it is determined that the follower ID has been registered, the object integrator 146 determines whether or not there is a rival leader ID for the follower ID (step S406).

When it is determined that there is a rival leader ID, the object integrator 146 determines whether or not the distance between the rival leader ID and the follower ID is less than a threshold value (step S408). When it is determined that the distance is less than the threshold value or when it is determined that the distance from the nearest follower ID is not less than the threshold value in the processing of step S402, the object integrator 146 sets the updated counter value for that global ID of the history information to “1” (step S410). Subsequently, the object recognizer 148 generates the object information 78 corresponding to the global ID (step S412).

When it is determined that the follower ID has not been registered in the history information 76 in the processing of step S404, the object integrator 146 determines whether or not there is a different nearest leader ID for the follower ID (step S414). When it is determined that there is a nearest leader ID, the object integrator 146 determines whether or not the distance between the rival leader ID and the follower ID is less than a threshold value (step S416). When it is determined that the distance is less than the threshold value, the object integrator 146 executes the above-described processing of steps S410 to S412. When it is determined that the distance is not less than the threshold value or when it is determined that there is no different nearest leader ID for the follower ID in the processing of step S414, the object integrator 146 overwrites the global ID of the follower ID with the global ID for the leader ID (step S418) and executes the above-described processing of steps S240 to S260 (step S420).

When it is determined that no rival leader ID for the follower ID in the processing of step S406, or when it is determined that the distance between the rival leader ID and the follower ID is not less than the threshold value in the processing of step S408, the object integrator 146 overwrites the global ID of the follower ID with the global ID of the leader ID and deletes the old global ID of the follower (step S422), and then performs the processing of step S420. Thereby, the process of this flowchart ends.

As shown in the above-described modification examples, in the integration process for objects located in the overlapping area, objects detected by the first camera (leader) and objects detected by the second camera (follower) are managed separately, such that objects can be integrated more appropriately. Thereby, it is possible to more accurately recognize objects near the mobile object M.

### Other modification examples

For example, in the embodiment, when a detected object is large (or long), an object may be located across a plurality of overlapping areas OA1 to OA6. In this case, the object integrator 146 may compare the object information (position information, label information, and feature information) of the objects integrated in each overlapping area and further integrate the objects. In this case, the history information 76 and the object information 78 are updated based on an integration result.

In the embodiment, a plurality of object detectors 142 may be provided for each of the plurality of cameras 11a to 11f installed on the mobile object M.

According to the above-described embodiment, the image processing device includes the acquirer 120 configured to acquire images captured by the plurality of cameras 11; the object detector 142 (an example of a detector) configured to detect objects from the plurality of images acquired by the acquirer 120; and the object integrator 146 configured to perform, when there are objects located in an overlapping area of the images from the plurality of cameras 11 among the objects detected by the object detector 142, an integration process on the objects detected by the plurality of cameras 11 based on a distance between the objects in the overlapping area detected by the plurality of cameras 11, types of the objects, and history information about a previous integration process on the objects, whereby visibility of objects included in images can be improved.

Specifically, in the embodiment, images are captured in a plurality of directions using a plurality of cameras, and it is determined whether or not objects detected within the plurality of captured images are the same object based on position coordinates, a position within a specified range, past history information, and the like. For example, in the embodiment, objects are detected using the plurality of cameras, their position coordinates in the vehicle coordinate system are calculated using homography transformation, and the object information from each camera is aggregated based on the object positions calculated for each camera. Furthermore, in the embodiment, when a plurality of objects that are candidates for integration are detected, appropriate pairs can be identified and integrated more quickly and efficiently with reference to history information about previous integration. In this way, when an object integration process based on history information about previous integration is performed, objects around the mobile object M can be recognized more quickly and accurately.

The embodiment described above can be represented as follows.

An image processing device comprising:

a storage medium storing computer-readable instructions; and

a processor connected to the storage medium, the processor executing the computer-readable instructions to:

acquire images captured by a plurality of cameras;

detect objects from the plurality of images that have been acquired; and

perform, when there are objects located in an overlapping area of the images from the plurality of cameras among the detected objects, an integration process on the objects detected by the plurality of cameras based on a distance between the objects in the overlapping area detected by the plurality of cameras, types of the objects, and history information about a previous integration process on the objects.

Although modes for carrying out the present invention have been described using embodiments, the present invention is not limited to the embodiments and various modifications and substitutions can also be made without departing from the scope and spirit of the present invention.

What is claimed is:

1. An image processing device comprising:
an acquirer configured to acquire images captured by a plurality of cameras;
a detector configured to detect objects from the plurality of images acquired by the acquirer; and
an integrator configured to perform, when there are objects located in an overlapping area of the images from the plurality of cameras among the objects detected by the detector, an integration process on the objects detected by the plurality of cameras based on a distance between the objects in the overlapping area detected by the plurality of cameras, types of the objects, and history information about a previous integration process on the objects.

2. The image processing device according to claim 1, wherein the history information is information in which at least common identification information for identifying the objects common to the plurality of cameras and camera-specific identification information separately assigned to the integrated object by each of the plurality of cameras are associated with the objects detected by the plurality of cameras.

3. The image processing device according to claim 1,
wherein the integrator iteratively executes the integration process using a plurality of images acquired at predetermined intervals from the plurality of cameras, and
wherein the integration process is performed with reference to the history information when a plurality of new objects are detected in the plurality of cameras.

4. The image processing device according to claim 1, wherein the integrator performs the integration process when images whose timings are synchronized are acquired from the plurality of cameras.

5. The image processing device according to claim 2,
wherein the integrator generates object information including common identification information of the integrated object, object position information, and object type information, and
wherein the object information includes feature information of the object.

6. The image processing device according to claim 5, wherein the integrator generates position information and feature information for the integrated object based on position information for each object and the object feature information before the integrated object is integrated.

7. The image processing device according to claim 1, wherein the integrator decides objects to be integrated with reference to the history information when there is at least one type of a plurality of objects detected from an image captured by a first camera among the plurality of cameras and a plurality of objects detected from an image captured by a second camera different from the first camera.

8. The image processing device according to claim 7, wherein the integrator excludes an object integrated with another object among the plurality of objects from a target of the integration process with reference to the history information for each of the plurality of objects detected from images captured by the first camera or the second camera.

9. An image processing method comprising:
acquiring, by a computer, images captured by a plurality of cameras;
detecting, by the computer, objects from the plurality of images that have been acquired; and
performing, by the computer, when there are objects located in an overlapping area of the images from the plurality of cameras among the detected objects, an integration process on the objects detected by the plurality of cameras based on a distance between the objects in the overlapping area detected by the plurality of cameras, types of the objects, and history information about a previous integration process on the objects.

10. A computer-readable non-transitory storage medium storing a program for causing a computer to:
acquire images captured by a plurality of cameras;
detect objects from the plurality of images that have been acquired; and
perform, when there are objects located in an overlapping area of the images from the plurality of cameras among the detected objects, an integration process on the objects detected by the plurality of cameras based on a distance between the objects in the overlapping area detected by the plurality of cameras, types of the objects, and history information about a previous integration process on the objects.
